(19) United States
(12) Patent Application Publication
(10) Pub. No.: US 2007/0294691 A1
(43) Pub. Date: Dec. 20, 2007

(54) APPARATUS AND METHOD FOR PROGRAM EXECUTION IN PORTABLE COMMUNICATION TERMINAL

(75) Inventor: Jae-Hyun Park, Incheon (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon -si (KR)

(21) Appl. No.: 11/753,340

(22) Filed: May 24, 2007

(30) Foreign Application Priority Data
Jun. 15, 2006 (KR) 2006-0053776

(51) Int. Cl. G06F 9/46

(52) U.S. Cl. 718/100

(57) ABSTRACT

An apparatus and method for controlling an execution of a program in a mobile communication terminal. The apparatus includes a history manager that manages history data required for executing the program, and a controller that estimates a required memory size for executing the program by obtaining a memory size being used in the mobile communication when the program is executed, and instructs the history manager to update the history data. Only when the size of the available memory of the mobile communication terminal is equal to or greater than the size of the estimated required memory, is the program executed.

### PRIORITY

This application claims priority under 35 U.S.C. § 119 to an application filed in the Korean Intellectual Property Office on Jun. 15, 2006 and assigned Serial No. 2006-53776, the contents of which are incorporated herein by reference.

### BACKGROUND OF THE INVENTION

1. Field of the Invention

The present invention relates generally to an apparatus and method for program execution considering memory size in a mobile communication terminal, and more particularly, to an apparatus and method for estimating the memory size required to execute a program in a mobile communication terminal and determining whether the program can be executed.

2. Description of the Related Art

As mobile communication terminals have become indispensable, the demand for consumer items, has increased. Consequently, service providers and terminal manufacturers are competitively developing new products, services, and functions to attract potential users.

For example, mobile communication terminals have phone directories, games, short message service, e-mail, wake-up call alarm, MPEG (Moving Pictures Experts Group) Layer 3 (MP3), digital camera, wireless Internet, and a variety of other functions and services.

To use the above functions and/or services, a mobile communication terminal must have enough usable memory to execute these functions and/or services used with the programs. For example, when a user inputs a command to run a program, the mobile communication terminal compares usable memory currently available with a minimum memory capacity required to run a corresponding program to determine whether the mobile communication terminal is able to run the program.

That is, if the minimum memory needed to run a program is less than the size of available memory in a mobile communication terminal, the communication terminal can execute the program.

However, when a program is thus executed, the loading of libraries, images, storage data, etc., and the performance of other functions of the program typically requires additional memory capacity. Specifically, if the available memory is insufficient to cover the additional memory requirements, the program will not be able to function properly, and may shut down prematurely.

Accordingly, an apparatus and method that estimate not only the amount of memory needed to run a program, but also the memory required during the program execution for additional functions, such as the loading of libraries, images, and storage data, etc., in order to determine whether the program can be correctly executed, are required.

### SUMMARY OF THE INVENTION

An object of the present invention is to substantially solve at least the above problems and/or disadvantages and to provide at least the advantages below. Accordingly, an object of the present invention is to provide an apparatus and method for estimating the memory size needed to run a program.

Another object of the present invention is to provide an apparatus and method that determine whether a program may be executed in a mobile communication terminal, based on the size of available memory.

According to a first aspect of the present invention, there is provided an apparatus for controlling an execution of a program in a mobile communication terminal, including a history manager for managing history data required for executing the program, and a controller for obtaining data corresponding to a memory size currently being used in the mobile communication terminal after executing the program, estimating a required memory size for executing the program using this data, and instructing the history manager to update the history data.

According to a second aspect of the present invention, there is provided a method of updating history data corresponding to a program, the method including estimating a required memory size through monitoring a memory size being used after the program is executed; and storing the estimated required memory size.

According to a third aspect of the present invention, there is provided a method of controlling an execution of a program in a mobile communication terminal, the method including determining whether history data corresponding to the program exists, when a command for executing the program is detected; determining a required memory size of the program, when it is determined that the history data exists; determining an available memory size of the mobile communication terminal; and comparing the required memory size with the available memory size to determine whether the required memory size is less than or equal to the available memory size; and executing the program when it is determined that the required memory size is less than or equal to the available memory size.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a mobile communication terminal for executing a program according to the present invention;

FIG. 2 is a flowchart illustrating a process for determining a memory capacity required to execute a program in a mobile communication terminal according to the present invention; and

FIG. 3 is a flowchart illustrating a process for controlling the execution of a program in a mobile communication terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Below, a description will be given of an apparatus and method for determining whether a program may be executed by checking the required memory capacity needed to execute the program and the memory capacity needed to perform additional functions of the program.

As used herein, the required memory capacity refers to the size of memory needed to run a program and the memory required during the program's execution for executing additional functions, such as the loading of libraries, images, storage data, etc.

A method for estimating the memory size required to properly execute a program according to the present invention is provided. First, the program is run, and thereafter the size of the used memory is measured at the time when the size of memory used by the program is constant. It is then determined whether to run the program again at an appropriate time using the measured value (as a reference).

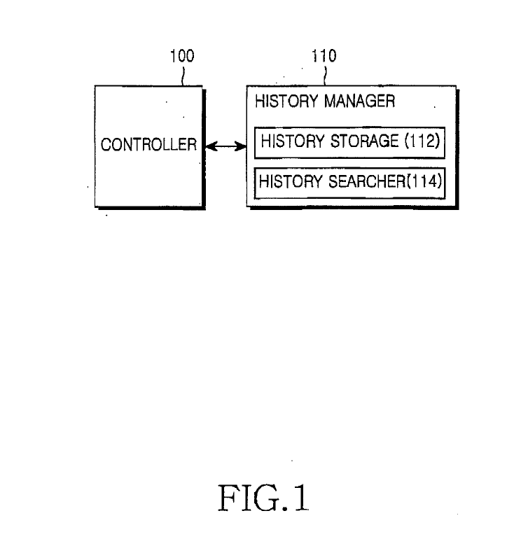

FIG. 1 is a block diagram of a mobile communication terminal for executing a program according to the present invention.

Referring to FIG. 1, the mobile communication terminal includes a controller 100 and an optional history manager 110. The history manager includes an history storage area 112 and history searcher 114.

The controller 100 controls the execution of programs in the mobile communication terminal. For example, in addition to performing its conventional duties, the controller 100 according to the present invention manages the resources used by the programs. After executing a program, the controller 100 estimates the required memory capacity (or required memory size) and controls the history manager 110 to store the data in the history storage area 112.

Also, when a user inputs a command to run a program, the controller 100 obtains the available memory capacity of the mobile communication terminal, and compares the obtained available memory capacity with the required memory size obtained through the history manager 110, to determine whether the program may be properly executed.

When the program is executed, the history manager 110 stores the memory size required by the program that is estimated by the controller 100 in the history storage area 112.

Also, the history manager 110 directs the history searcher 114 through commands received from the controller 100 to search required memory size data stored in the history storage area 112.

The history storage area 112 is controlled by the history manager 110 to store history data including the required memory size of a program estimated by the controller 100. The history searcher 114 is instructed by the history manager 110 to search for history data corresponding to the program from the history data stored in the history storage area 112.

The above description is directed to an apparatus for estimating the required memory size to run a program in a mobile communication terminal and for determining whether to execute the program based on the required memory size. The description below will explain a method of estimating the required memory size to run a program in a mobile communication terminal, and determining whether to execute the program.

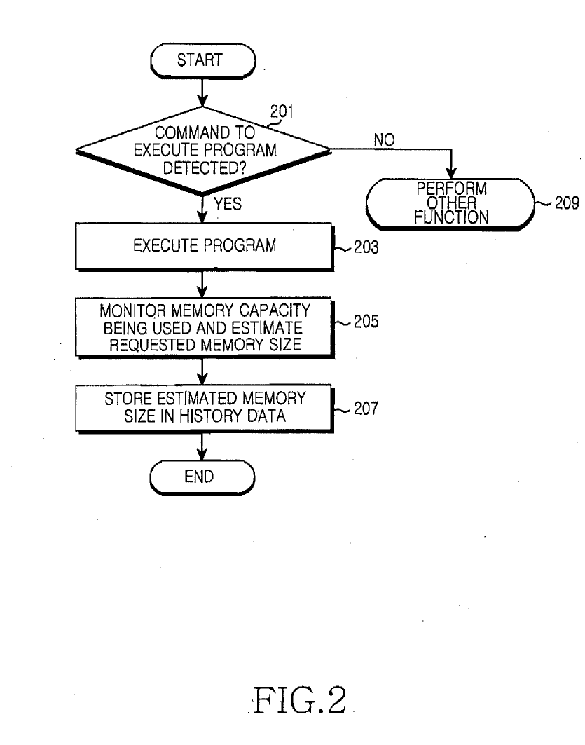

FIG. 2 is a flowchart illustrating a process for determining a memory capacity required to execute a program in a mobile communication terminal according to the present invention.

Referring to FIG. 2, the controller 100 detects whether a user has entered a command to run a program in step 201. If the result of step 201 determines that there was no such command entered, the controller 100 skips to step 209 to perform another function (for example, standby mode, etc.).

If it is detected in step 201 that there was a user command to execute the program, the controller 100 executes the requested program in step 203, and then performs step 205, in which it measures the size of available memory in the mobile communication terminal during the running of the program, and estimates the required memory size of the program.

Here, the required memory size is a memory size required at an initial executing point of the program, plus an additional memory size required to perform other functions of the program, such as loading a library, images, and storage data.

Also, the step of estimating of the required memory size may be performed at a point when the size of the memory being used by the program stabilizes after the program is executed. However, the step of estimating the required memory size can be performed at a predetermined time after executing the program and/or when the controller 100 activity level corresponds with a certain threshold level.

Then, the controller 100 instructs the history manager 110 in step 207 to update the history data with the estimated required memory size.

Next, the controller 100 ends the current process.

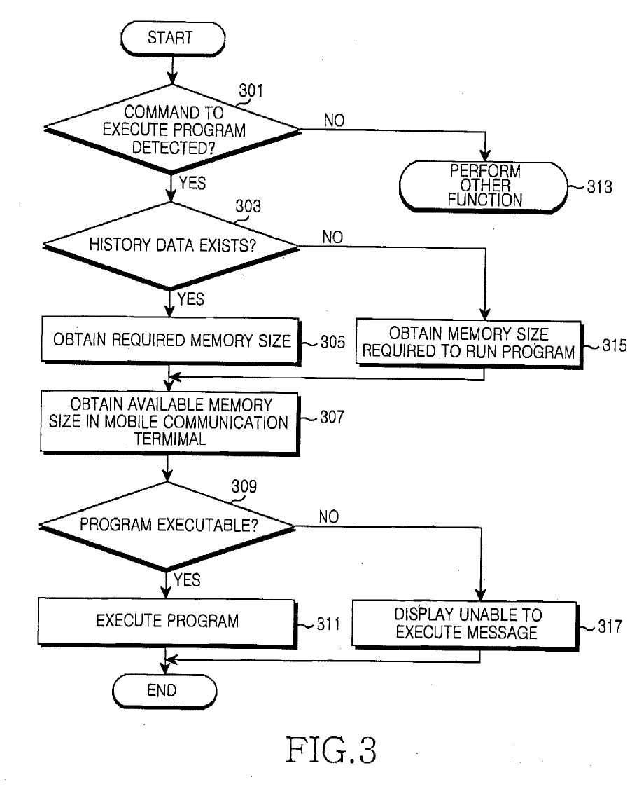

FIG. 3 is a flowchart illustrating a process for controlling the execution of a program in a mobile communication terminal according to the present invention.

Referring to FIG. 3, the controller 100 first detects whether a user's command for executing a program has been inputted in step 301. If no input of a user's command is detected, the controller 100 skips to step 313 to perform another function (for example, standby mode, etc).

If it is detected that there was a user command to execute the program, the controller 100 controls the history manager 110 in step 303 to determine whether history data exists. The determining of whether the history data exists is performed by the history manager 110 which controls the history searcher 114, to determine whether there is a history data among the plurality of history data stored in the history storage 112 that is required to execute the program.

If it is determined that the history data does not exist, the controller 100 performs step 315 in which it obtains a required memory size for executing the program based on the sizes of the executed program and options added for executing the program and other data related to memory. Then, the controller 100 obtains the usable memory (available memory) of the mobile communication terminal in step 307.

However, if it is determined that the history data exists, the controller 100 obtains the required memory data included in the history data in step 305, and obtains the size of the usable memory (available memory) of the mobile communication terminal in step 307.

Next, the controller 100 performs step 309, in which it compares the size of the required memory size included in the history data with the usable memory (available memory size) obtained in step 307, in order to determine whether the program may be executable. That is, it is determined whether the required memory size included in the history data is larger or smaller than (or equal to) the usable memory (available memory) of the mobile communication terminal, upon which the determining of whether the program is executable is based.

If as a result of the determining in step 309, it is determined that the program is not executable, the controller 100 performs step 317, in which it displays a message on the display (not shown) of the mobile communication terminal to that effect in step 317.

If, as a result of the determining in step 309, it is determined that the program is executable, the controller 100 executes the program in step 311, and ends the current process.

As described above, the present invention, estimates the size of the memory required to execute a program, and executes a program when there is enough available memory in the mobile communication terminal to cover the estimated required memory when executing the program again. Thus, the operational stability of the mobile communication terminal of the present invention is enhanced and the likelihood of a the program prematurely ending due to insufficient memory is reduced.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the present invention should not be limited to the above-described embodiments or the claims appended below, and should encompass embodiments similar to the claims.

What is claimed is:

1. An apparatus for controlling an execution of a program in a mobile communication terminal, comprising:
a history manager for managing history data required for executing the program; and
a controller for executing the program;
estimating a required memory size for executing the program by determining an amount of memory being used in the mobile communication terminal while the program is executed; and
controlling the history manager to update the history data.

2. The apparatus of claim 1, wherein the history manager comprises.
a history storage area for storing the history data, the history data including the required memory size for executing the program; and
a history searcher for searching for corresponding history data required to execute the program from a plurality of history data stored in the history storage area.

3. The apparatus of claim 2, wherein the controller determines whether the program is executable by determining an available memory size of the mobile communication terminal and comparing the available memory size with the required memory size, when a command for executing the program is detected.

4. The apparatus of claim 3, wherein the controller displays a message indicating that the program cannot be executed, when the controller determines that the program is not executable.

5. The apparatus of claim 1, wherein the required memory size is a memory size including an amount of memory required at an initial executing point of the program and an amount of memory required to execute additional functions during the execution of the program.

6. A method of updating history data corresponding to a program, the method comprising the steps of:
estimating a required memory size by determining an amount of memory being used after the program is executed; and
storing the estimated required memory size.

7. The method of claim 6, wherein the required memory size is a memory size required at an initial executing point of the program and an amount of memory size required to execute additional functions during the execution of the program.

8. A method of controlling an execution of a program in a mobile communication terminal, the method comprising the steps of:
determining whether history data corresponding to the program exists;
obtaining a required memory size of the program, when it is determined that the history data exists;
obtaining an available memory size of the mobile communication terminal; and
comparing the required memory size with the available memory size to determine whether the required memory size is less than or equal to the available memory size, and executing the program when it is determined that the required memory size is less than or equal to the available memory size.

9. The method of claim 8, further comprising displaying a message that the program cannot be executed, when it is determined that the required memory size is greater than the available memory size.

10. The method of claim 8, wherein the required memory size is a memory size required at an initial executing point of the program and an amount of memory required to execute additional functions during the execution of the program.

11. A mobile communication terminal for controlling an execution of a program, comprising:
means for determining whether a program is executable by determining an available memory size and comparing the available memory size with the required memory size for executing the program.

12. The mobile communication terminal of claim 11, further comprising a history manager for storing memory size data required for executing the program.

13. The mobile communication terminal of claim 11, further comprising means for displaying a message indicating that the program cannot be executed, when the program is not executable.

14. A method of controlling an execution of a program, the method comprising the steps of:
determining whether a program is executable by comparing the available memory size with the required memory size for executing the program.

15. The method of claim 14, further comprising a step of storing memory size data required for executing the program.

16. The method of claim 14, further comprising a step of displaying a message indicating that the program cannot be executed, when the program is not executable.
